(19) United States
(12) Patent Application Publication
(10) Pub. No.: US 2006/0256475 A1
(43) Pub. Date: Nov. 16, 2006

(54) Cassette adapter including integral mounting of a portable audio player with integral connection means

(76) Inventors: Joshua Lindsay, Woodside, CA (US); Frank Inzerillo, Livermore, CA (US); Wayne Miller, Livermore, CA (US); Adam Lindsay, Bay Village, OH (US)

Correspondence Address: DEBRA A. CHUN, 36 SHERLAND AVE., MOUNTAIN VIEW, CA, 94043, US

(21) Appl. No.: 11/128,777

(22) Filed: May 12, 2005

(51) Int. Cl. G11B 15/10

(52) U.S. Cl. 360/137

(57) ABSTRACT

An adapter, for enabling signals produced by a portable audio player to be reproduced as audio sounds by a cassette player audio system having a cassette audio playback deck, includes a housing of a configuration of a cassette normally used with the playback deck, a record head supported in a peripheral front wall of the housing, an extension of the housing protruding from the loading opening in the front of the cassette player for the purpose of holding said portable audio player in a convenient location on the front of the cassette deck. The adapter can also include an integrated electrical generator for charging the portable audio player. Also, an integrated device for holding a portable audio player directly onto the removable faceplate of a car stereo is set forth.

### BACKGROUND

The present invention relates generally to an adapter for use in a cassette player audio system. More particularly, the invention relates to an adapter that enables audio signals from a portable audio device to be played through, or reproduced by, a cassette player audio system.

Recently, new formats have become available for high fidelity sound reproduction. One type of format is the digital audio player commonly known as an MP3 player. A typical MP3 player includes a hard disk drive and a DRAM memory buffer, although many models use only non-volatile solid-state memory. The format of the data files encoding the music is significantly compressed compared to that used for compact disks or other previous encoding schemes, allowing significant reduction in the amount of disk storage space required per song. This, combined with large advances in the density of hard disk storage, has enabled the emergence of hand-held players such as the Apple iPod, the Creative Labs' Zen, and other very compact players capable of holding a user's complete music collection within the playback device. Users can easily convert music from their Compact Disks into MP3 format using free software on their home computers, and there is a large and growing market for music already in MP3 format that can be downloaded from the internet. Such compact players are thus a significant improvement over CD players and tape cassettes that employ removable media. Additionally, the compactness of the electronics required to provide digital audio functionality has made it possible to include digital audio functionality within other devices, such as telephones and personal digital assistants (PDAs).

Prior to the introduction of the aforementioned compact disc and player, sound systems, such as those provided in automobiles, generally have utilized tape cassettes as the source from which audio signals are played back. Cassettes utilize magnetic tape on which high fidelity music has been recorded. The sound systems with which such cassettes are compatible include a playback deck that receives the cassette or cartridge, reproduces the signals that had been recorded on the magnetic tape therein and converts those signals to audible sounds. Significant investments have been made by consumers to provide high quality sound systems in their automobiles and elsewhere for the purpose of enjoying prerecorded cassettes. Some new cars offer an optional attachment for an MP3 player, such as the Apple iPod, and this is expected to increase as a trend.

Several methods have been employed for playback of MP3 players through existing stereos in cars, but each of these has drawbacks. The three general categories of devices that are currently used to adapt portable players to car stereos are: radio frequency transmitters, which broadcast low-power FM signals that are received by the car's radio; generic cassette-tape player adapters, which play via a wire from the headphone jack of the player through an adapter that takes the form of a cassette tape, coupling the audio signal through a magnetic head into the playback head of the car's cassette deck; and direct-attachment to the car's stereo via auxiliary audio inputs.

The problem with the radio transmitters is that they are limited in power by FCC regulations to levels that are easily overwhelmed by broadcast radio stations. This problem is especially acute in major metropolitan areas where there are many radio stations crowding the FM bands.

An exemplary prior art cassette type adapter is taught by U.S. Pat. No. 4,734,897. The adapter described is in the form of a simple compact cassette employing a loose wire connecting to the playback head inside the cassette, and protruding from the front of the cassette deck, with a connector at the other end to connect to the audio source. This type of prior art cassette-deck adapters has a wire dangling out of the front of the cassette deck, and does not provide a means for holding the portable player, nor does it provide a means for charging the battery of the player. This results in a cluttered and unsightly mess of wires around the dashboard, and the player usually rests on a vacant seat or is dropped into a cup holder, or balanced precariously on the dashboard or center console.

Finally, the direct-attached units are the best method, but tend to be very expensive, require special stereos with auxiliary inputs, and typically require expert installation. They also generally plug into the player via a wire coming out from beneath the dashboard or in the glove box, presenting similar mounting issues as the other choices.

Thus, there exists a need for a reliable, inexpensive and easy to use adapter that enables a portable device to be used with, or played through, a cassette player system.

### SUMMARY OF THE INVENTION

The present invention solves the above described need. The present invention has for its object to provide an improved adapter. To this end, an adapter in accordance with principles of the present invention is characterized in that an audio source, for example a portable audio player such as an MP3 player, is mounted directly to an extension of the adapter so that it is positioned conveniently and cleanly with no loose wires.

A further object of the present invention is to provide an adapter by which a portable device, such as a portable audio player or other playback device of different format, and a cassette player are made compatible without requiring rewiring or reconstruction of the audio system in which the cassette player is a part.

A still further object of the present invention is to provide a means by which the batteries of the portable device can be charged without the need for a standard cigarette-lighter adapter and its associated wire, by employing a generator within the cassette adapter to generate electricity to charge the device, that is driven by the cassette deck mechanism. An exemplary prior art for a generator of this type is taught in U.S. Pat. No. 6,420,849.

The present invention is directed to an adapter for enabling signals produced by a signal source, such as a portable audio player, personal digital assistant or telephone device, to be reproduced as audio sounds by a cassette player audio system having a cassette audio playback deck. An adapter, according to principles of the present invention, includes a housing having a configuration of a cassette normally used with the cassette playback deck, a record head supported in a peripheral front wall of the housing, and an extension of said housing for mounting of the signal source and providing an electrical coupling from the signal source to the adapter for providing audio signals to the record head to allow playback through the audio system of the cassette playback deck. A holder is attached to the extension of the housing for mounting the signal source. The holder can include a docking connector and an auxiliary power connecter. The auxiliary power connector can be used for charging the batteries of the portable audio player, using either power from a generator integrated into the adapter or power from an auxiliary power source.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 shows a perspective view of one preferred embodiment of an adapter according to principles of the present invention;

FIG. 2 shows a side view of the adapter with a digital audio player, of the type that has a docking connector, mounted in the holder;

FIG. 3 shows the adapter with a digital audio player, of the type that has a docking connector, mounted in the holder;

FIG. 4 shows a cutaway view of the holder showing the circuit board and docking connector.

FIG. 5 shows an additional embodiment of an adapter for use with a digital audio player that has no docking connector;

FIG. 6 shows an implementation of an internal generator inside the cassette;

FIG. 7 shows an adapter according to principles of the present invention with an auxiliary power input cable;

FIG. 8 shows a side view of the adapter in a simplified configuration with a fixed mounting for the player instead of the ball pivot; and

FIG. 9 shows another embodiment of the invention with a removable car stereo faceplate in the place of the cassette adapter.

### DESCRIPTION

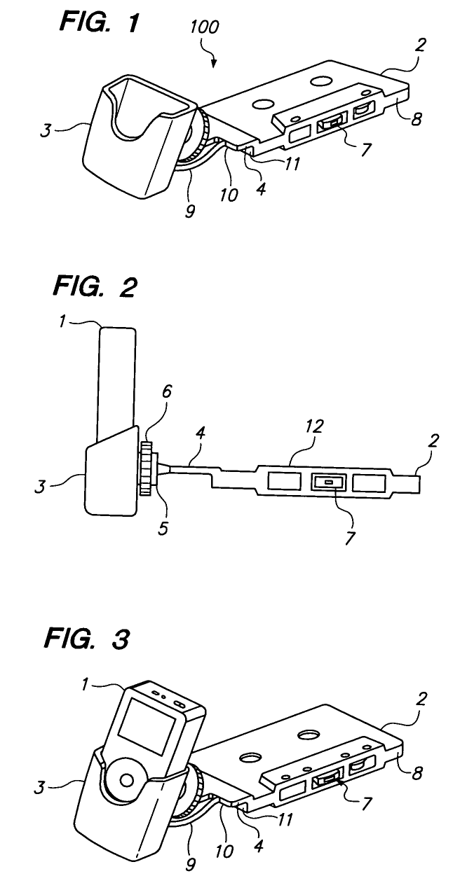

Referring to FIG. 1, a perspective view of one embodiment of an adapter according to principles of the present invention is shown. The adapter 100 includes a housing 2 having a configuration of a cassette normally used with an audio cassette playback deck. As used herein, the expression “cassette” is intended to refer to conventional reel-to-reel magnetic tape cassettes, such as the so-called “standard” or “Philips” type cassette or the so-called “micro” cassette. The housing 2 includes an extension 4 protruding from the housing 2 on which a holder 3 for a portable audio device 1 (see FIG. 2) is integrated. When the adapter 100 is inserted into the cassette playback deck the extension 4 protrudes from the opening of the cassette playback deck such that a portable audio device 1 can be mounted in the holder 3. The holder 3 can be specifically designed for use with any of several commercially available portable players, which may employ different connecting means for transmitting audio signals, receiving electrical charging current, and receiving electronic control signals. Preferably, the holder 3 is connected to the extension 4 using a ball joint 5, as seen in FIG. 2, to allow rotation of the holder 3. A mechanism 6 provides tightening force to adjust the friction in the ball joint 5. Other clamp, hinge or similar type fastening means which allows tensioned movement of the holder can be used to connect the holder 3 to the extension 4. Alternatively, the holder 3 can also be fixedly attached to the extension 4, as shown in the embodiment illustrated in FIG. 8.

Turning now to FIG. 3, the adapter according to principles of the present invention is shown with an MP3 player mounted in the holder 3. The housing 2 of the adapter 100 has at least one opening to receive at least one reel-drive spindle of the cassette playback deck, and a record head 7 supported in the housing 2 in a position for contacting the playback head normally provided in the playback deck. The record head 7 is supported in a peripheral side wall 8 of the housing 2. An electrical conducting means 9, in the form of a plurality of electrical wires, is located partly within the housing and extends from the housing to a docking connector 14 mounted in the holder 3, or to a headphone jack connector for use with a type of portable audio player 1 which does not employ a docking connector. The conducting means 9 has one end electrically coupled to the record head 7, which may preferably be a stereo record head, for providing a stereo audio signal to the record head 7. The other end of the conducting means 9 is coupled to a docking connector 14 integrated into the holder 3, for receiving the audio signals from the audio source, such as the MP3 player or other type of audio player. An opening 10 is provided in the extension 4 which extends from a front wall 11 of the housing 2, via which the electrical conducting means 9 extends from the adapter. Preferably, the electrical conducting means 9 passes into the housing 2 through an opening 10 in the peripheral wall thereof. The opening 10 is positioned such that the electrical conducting means 9 does not interfere with the internal mechanism of the playback deck. In one embodiment the electrical conducting means 9 can be routed through a front corner of the adapter housing 2 and directly into a channel in the previously mentioned extension. Since the standard “Philips” cassette has a thicker section 12, as seen in FIG. 2, running along the central section of this side wall to provide space for the playback head of the cassette deck to contact the tape, and the playback decks generally have a wider opening in the faceplate of the playback deck in this area, there is no impediment to the electrical conductor when the conductor is deployed in this area.

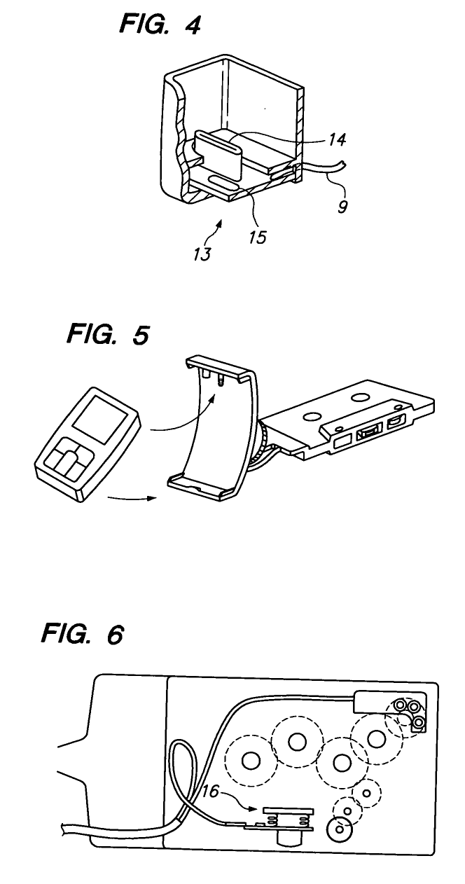

Referring now to FIG. 4, features of the holder 3 will now be nominally described. The electrical conducting means 9 connects into the holder 3, which may contain a printed circuit board 13 which includes a docking connector 14 for connection into the audio player 1, and an auxiliary power connector 15. The docking connector 14 can be a standard type docking connector suitable for the particular portable device being used. Similarly, the auxiliary power connector 15 would be configured to fit the power supply connector receptacle of the portable device.

Turning now to FIG. 5, an alternative embodiment of an adapter according to principles of the present invention is shown. As seen here, the adapter is used with a portable device 1, of the type that has no docking connector. In this embodiment, the portable device 1, in this case a digital audio player of the type employing a USB (Universal Serial Bus) connector and headphone jack, is mounted in the holder 3 and the electrical conductor connects to the headphone jack to transmit the audio signal to the record head. Additionally, a USB connector is included to transmit power for charging the battery of the portable device.

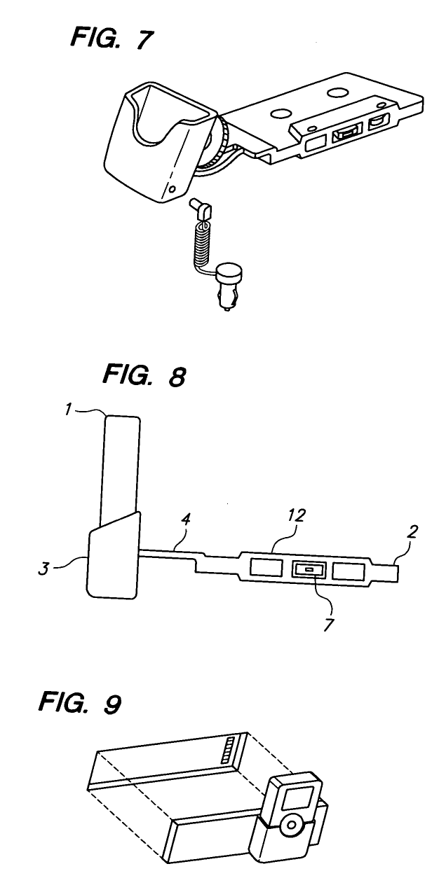

FIG. 6 shows an additional feature of the adapter of the present invention. Here, an internal generator 16 is included within the housing 2 of the adapter 100. The internal generator 16 connects to the electrical conductor 9 and can charge the portable device 1 while it is being operated. The internal generator nominally consists of a set of rotating permanent magnets which rotate past a set of electrical coils and is driven by a tape drive spindle. Alternatively, as shown in FIG. 7, the portable device 1 can be charged using an auxiliary power cable which is plugged into a power source, such as a cigarette lighter power adapter, or like power source in an automobile. In this case, the auxiliary power cable is plugged into a receptacle in the holder 3 of the adapter 100 which is in turn plugged into the portable device 1.

In a still further embodiment, an adapter according to principles of the present invention includes a removable stereo faceplate which is used as the housing portion of the adapter, as shown in FIG. 9. Here, the holder is connected to the front panel of the faceplate. Such an implementation would be designed to connect directly to the specific electrical connection means of the specific stereo deck.

In operation, when the adapter 100 is loaded into the cassette playback deck, and that deck as well as the portable device 1 mounted on the adapter 100 are both operated, signals produced by the portable device 1 are coupled, by means of the electrical conductor 9 and audio circuit, to the record head 7. The signals from the record head 7 are then coupled to the playback head of the cassette playback deck and those signals are reproduced by the audio system. Optionally, another set of conductors is connected at one end to a generator circuit within the adapter 100, and is connected at its other to the charging plug on the portable audio player 1.

While the particular embodiments of the adapter as illustrated herein are fully capable of satisfying the needs and providing the advantages herein before stated, it is to be understood that it is merely illustrative of the presently preferred embodiments of the invention and that no limitations are intended to the details of construction or design herein shown other than as described in the appended claims.

What is claimed is:

1. An adapter for enabling signals produced by a signal source to be reproduced as audio sounds by a cassette player audio system, the adapter comprising:
a housing having a body portion in a shape of a cassette used with the cassette player audio system, and an extension portion extending from the body;
a holder connected to the extension portion of the housing for mounting the signal source onto the adapter;
a record head supported in a peripheral side wall of the housing for contacting a playback head of cassette player audio system; and
a means for electrically coupling the signal source and the record head.

2. The adapter of claim 1, wherein the holder comprises a connector for coupling with a docking connector on the signal source.

3. The adapter of claim 2, wherein the holder further comprises an auxiliary power element for charging the signal source mounted to the adapter.

4. The adapter of claim 3, further comprising an internal generator within the housing, and wherein the internal generator is coupled to the signal source for charging the signal source while mounted to the adapter.

5. The adapter of claim 3, wherein the auxiliary power element is coupled to an external power source for charging the signal source mounted to the adapter.

6. The adapter of claim 1, wherein the holder is movably connected to the extension portion of the housing such that the signal source can be viewed and operated from different angles.

7. The adapter of claim 1, wherein the holder is fixedly connected to the extension portion of the housing.

8. The adapter of claim 1, wherein the signal source is a portable audio device.

9. The adapter of claim 1, wherein the signal source is a cell phone type device.

10. The adapter of claim 1, wherein the signal source is a PDA (personal digital assistant) type device.

11. An adapter for enabling signals produced by a portable audio player to be reproduced as audio signals by an audio system having a removable faceplate, the adapter comprising:
a housing configured in a shape of the removable faceplate;
a mounting means attached to a front panel of the housing for mounting the portable audio player on the adapter; and
means for electrically coupling the portable audio player to the audio system, wherein operation of the portable audio player produces audio signals output from the audio system.
